(19) United States
(12) Patent Application Publication
(10) Pub. No.: US 2008/0118241 A1
(43) Pub. Date: May 22, 2008

(54) Control of stray light in camera systems employing an optics stack and associated methods

(76) Inventors: Robert TeKolste, Charlotte, NC (US); Bruce McWilliams, San Jose, CA (US); Hongtao Han, Mooresville, NC (US); William Hudson Welch, Charlotte, NC (US)

Correspondence Address: DIGITAL OPTICS CORPORATION, C/O LEE & MORSE, P.C., 3141 FAIRVIEW PARK DRIVE, SUITE 500, FALLS CHURCH, VA, 22042, US

(21) Appl. No.: 11/600,282

(22) Filed: Nov. 16, 2006

(51) Int. Cl. G03B 17/00

(52) U.S. Cl. 396/439

(57) ABSTRACT

A camera system may include an optics stack including two substrates secured together in a vertical direction and an optical system on the two substrates, the two substrates having exposed sides, a detector on a detector substrate, and a stray light blocker directly on at least some sides of the optics stack.

### FIELD OF THE INVENTION

The present invention is directed to a camera system and associated methods. More particularly, the present invention is directed to a camera system including an optics stack having reduced stray light.

### BACKGROUND OF THE INVENTION

Cameras may include an optics stack of optical substrates secured to one another at planar portions thereof. A plurality of these optics stacks may be made simultaneously, e.g., at a wafer level.

Further, since the optical system may be formed of a vertical stack of substrates secured to one another, a housing, e.g., a barrel, may not be needed for mounting lenses in the optical system. While elimination of such a housing may provide many advantages, including increased simplicity and reduced cost, such an optical system itself may have transparent sides along which the stack was separated, e.g., diced, from a rest of a wafer.

Such sides may allow light to enter the optics stack at other than the designed entrance pupil and/or may allow light incident at high angles on the designed entrance pupil to be reflected from an edge onto the sensor. In other words, light entering from the sides externally may increase noise and/or light reflected internally from the sides may increase noise.

### SUMMARY OF THE INVENTION

The present invention is therefore directed to a camera system employing an optics stack and associated methods, which substantially overcome one or more of the problems due to the limitations and disadvantages of the related art.

It is therefore a feature of the present invention to provide a material preventing external stray light from reaching a detector of the camera system.

It is another feature of the present invention to provide a material preventing internally reflected stray light from reaching the detector of the camera system.

At least one of the above and other features and advantages of the present invention by providing a camera system, including an optics stack including two substrates secured together in a vertical direction and an optical system on the two substrates, the two substrates having exposed sides, a detector on a detector substrate, and a stray light blocker directly on at least some sides of the optics stack.

The at least some sides may include sides on a substrate in the optics stack furthest away from the detector substrate. The stray light blocker may be on all sides of the optics stack.

The stray light blocker may have an index of refraction that is approximately equal to that of a substrate having the at least some sides. The stray light blocker may be an encapsulant. The stray light blocker may be a coating. The stray light blocker may be opaque to wavelengths the detector can detect.

One substrate in the optics stack may have a smaller surface area than the detector substrate. The substrates in the optics stack may be coextensive.

The detector substrate may extend beyond the optics stack in at least one direction. Bonding pads may be on the detector substrate extending beyond the optics stack. The camera system may include a substrate having elements to be electrically connected to the bonding pads.

The stray light blocker may include an encapsulant extending from an upper surface of the optics stack to the detector substrate. The encapsulant may cover the bonding pads and electrical connectors between the bonding pads and the substrate. The camera system may include features on the substrate restraining the encapsulant.

The camera system may include a housing surrounding the optics stack. The detector substrate may extend beyond the optics stack in at least one direction. Bonding pads may be on the detector substrate extending beyond the optics stack. The camera system may include a substrate having elements to be electrically connected to the bonding pads. The housing surrounding the optics stack may extend down to the substrate.

Substrates in the optics stack may not be coextensive. The housing may extend to cover an upper portion of the optics stack extending beyond other substrates. The stray light blocker may include an encapsulant between an opening in an upper surface of the housing and the upper portion of the optics stack extending beyond other substrates. The stray light blocker may include an encapsulant between the housing and the optics stack.

Substrates in the optics stack may not be coextensive. The stray light blocker may include an encapsulant along the optics stack.

A spacer separating the substrates in the optics stack may include a gap from the exposed sides. The stray light blocker may include an encapsulant along the optics stack, the encapsulant filling the gap.

Electrical interconnections through the detector substrate.

A cover plate on a detector substrate may extend beyond the optics stack in at least one direction. An opaque material may be an exposed surface of the cover plate. The opaque material is the same as the stray light blocker. The cover plate may have an angled edge and including an opaque material covering the angled edge of the cover plate. The opaque material is the same as the stray light blocker.

At least one of the above and other features and advantages of the present invention by providing a method of making a camera system, including securing an optics stack including two substrates secured together in a vertical direction and an optical system on the two substrates, the two substrates having exposed sides and a detector on a detector substrate, and providing a stray light blocker directly on at least some sides of the optics stack.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a cross-sectional view of a camera system in accordance with a first exemplary embodiment of the present invention;

FIG. 2 illustrates a cross-sectional view of a camera system in accordance with a second exemplary embodiment of the present invention;

FIG. 3 illustrates a cross-sectional view of a camera system in accordance with a third exemplary embodiment of the present invention;

FIG. 4 illustrates a cross-sectional view of a camera system in accordance with a fourth exemplary embodiment of the present invention;

FIG. 5 illustrates a cross-sectional view of a camera system in accordance with a fifth exemplary embodiment of the present invention;

FIG. 6 illustrates a cross-sectional view of a camera system in accordance with a sixth exemplary embodiment of the present invention;

FIG. 7 illustrates a cross-sectional view of a camera system in accordance with a seventh exemplary embodiment of the present invention;

FIG. 8 illustrates a cross-sectional view of a camera system in accordance with an eighth exemplary embodiment of the present invention; and

FIG. 9 illustrates a schematic elevational view of a camera system describing stray light issues generally.

### DETAILED DESCRIPTION

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the concept of the invention to those skilled in the art.

In the drawings, the thickness of layers and regions may be exaggerated for clarity. It will also be understood that when a layer is referred to as being “on” another layer or substrate, it may be directly on the other layer or substrate, or intervening layers may also be present. Further, it will be understood that when a layer is referred to as being “under” another layer, it may be directly under, or one or more intervening layers may also be present. In addition, it will also be understood that when a layer is referred to as being “between” two layers, it may be the only layer between the two layers, or one or more intervening layers may also be present. Like numbers refer to like elements throughout. As used herein, the term “wafer” is to mean any substrate on which a plurality of components are formed which are to be vertically separated prior to final use. Further, as used herein, the term “camera system” is to mean any system including an optical imaging system relaying optical signals to a detector, e.g., an image capture system, which outputs information, e.g., an image.

In accordance with embodiments of the present invention, a camera system utilizing lenses may include an optics stack having at least two substrates secured on a wafer level. The optics stack may include an optical imaging system. Substrates on which the optical imaging system is formed may have transparent edges that may be exposed, which may increase stray light reaching the detector, increasing noise. By providing a blocking material on at least some of the edges, this stray light may be reduced or eliminated.

As shown in the elevational schematic view of FIG. 9, a camera system 60 may include an optics stack 40 and a sealed detector 50. The optical stack 40 may include a first transparent substrate 10, a second transparent substrate 20, and a third transparent substrate 30. A light blocking material 12 may be provided on an upper surface of the first transparent substrate 10 to define an entrance pupil and block stray light from entering the camera system 60. However, remaining transparent surfaces of the optics stack 40 may allow light to enter the optics stack 40 at other than the designed entrance pupil and/or may allow light incident at high angles on the designed entrance pupil to be reflected from an edge onto the detector. For example, a light beam 1 may enter the optics stack 40 from a side externally and/or a light beam 2 may be reflected internally from a side of the optics stack 40, either of which may increase noise in the camera system 60. These problems may be exacerbated as a size of the optical substrates on which the optical system is formed is reduced and as the sides get closer to the sensor.

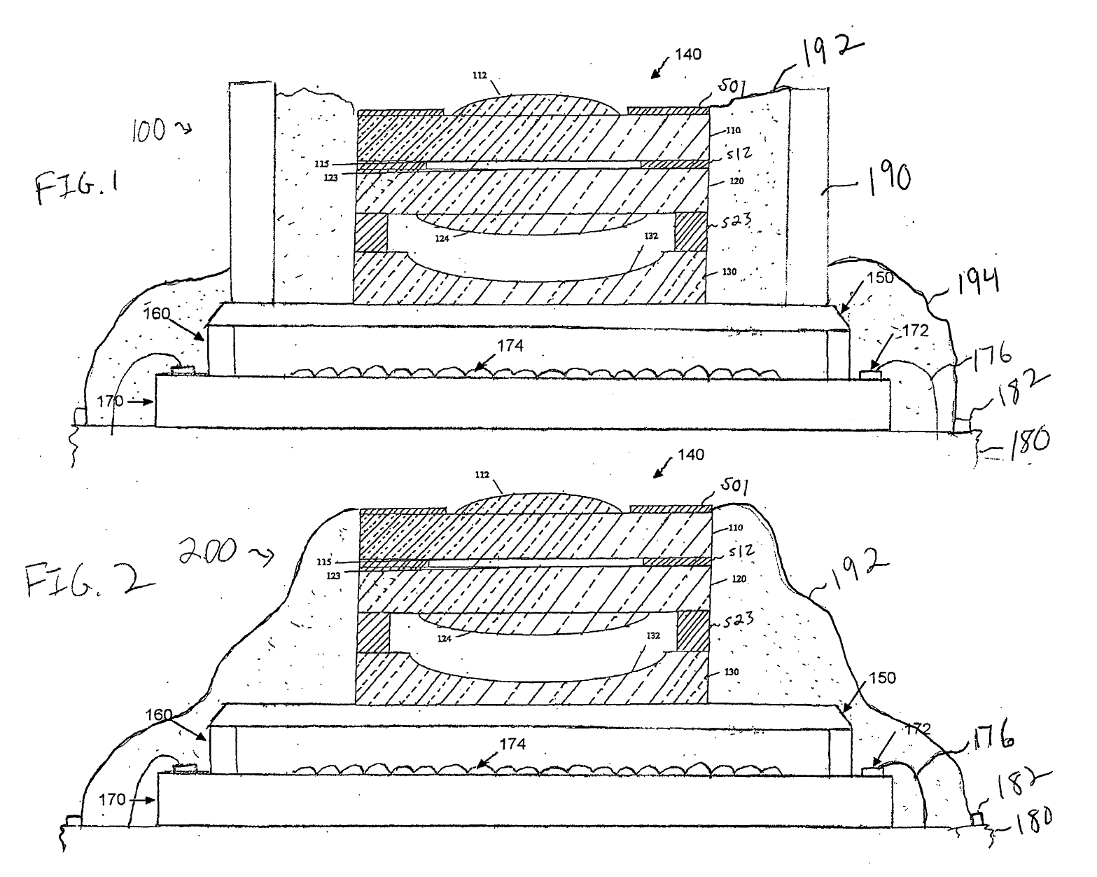

A camera system 100 in accordance with the first embodiment of the present invention is shown in FIG. 1. In FIG. 1, a single lens system may be used for all colors, and a color filter may be provided directly on a detector array. Alternatively, this lens system may be provided in any number, e.g., three or four, of sub-cameras for each camera system, while a design and/or location of the color filters may be varied. Such lens stack designs for a camera may be found, for example, in commonly assigned, co-pending U.S. Provisional Patent Application No. 60/855,365 filed Oct. 31, 2006 and U.S. patent application Ser. No. 11/487,580, filed Jul. 17, 2006, and Ser. No. 10/949,807, filed Sep. 27, 2004, all of which are hereby incorporated by reference in their entirety.

As illustrated in FIG. 1, the camera system 100 according to the first embodiment of the present invention may include an optics stack 140 and a detector substrate 170. The optics stack 140 may include a first substrate 110, a second substrate 120 and a third substrate 130, secured together by respective spacers S12 and S23. An additional spacer S01 may be provided on the first substrate 110 to serve as an aperture stop for the optics stack 140.

The first substrate 110 may include a first refractive convex surface 112, which may assist in imaging the light input thereto. A second surface 114 of the first substrate 110 may be planar, and may include an infrared filter 115 thereon. The infrared filter 115 may be on any of the surfaces in the optics stack 140

A first surface of the second substrate 120 may have a diffractive element 123 thereon, which may correct for color and camera aberrations. A second surface of the second substrate 120 may have a second refractive convex surface 124, which may further assist in imaging the light.

The third substrate 130 may have a refractive, concave surface 132 therein. The concave surface 132 may flatten the field of the image, so that all image points may be imaged at the same plane onto an active area of a detector array on the detector substrate 170.

A cover plate 150 and a standoff 160, providing accurate spacing between the optics stack 140 and the detector substrate 170, may be provided between the optics stack 140 and the detector substrate 170. The cover plate 150 and the standoff 160 may seal the active area. In addition to the active area, the detector substrate 170 may include an array of microlenses 174 and bond pads 172.

While the standoff 160 is illustrated as being a separate element from the detector substrate 170 and the cover plate 150, the standoff 160 may be integral with either one or both of the detector substrate 170 and the cover plate 150. Further, while sidewalls of the standoff 160 are shown as being straight, e.g., formed by dicing or patterning, they may be angled in accordance with how the standoff 160 is formed, e.g., at an etch angle of a particular material used for the standoff 160. Finally, the standoff 160 may be an adhesive material that is precisely provided on one or both of the detector substrate 170 and the cover plate 150, e.g., as disclosed in commonly assigned U.S. Pat. No. 6,669,803, which is herein incorporated by reference.

Similarly, while the cover plate 150 is illustrated as having beveled edges, this may be an artifact of a process used to create the cover plate 150, and may vary in accordance with different processes. In particular, when elements below a surface to be diced are to be protected, e.g., the dicing is not to occur through all secured wafers, an angled dicing blade may be employed. Further, the cover plate 150 may be transparent to light, e.g., glass, to be recorded by the camera system 100.

As shown in FIG. 1, the substrates 110, 120 and 130 may have opposing planar surfaces with the optical elements 112,115, 123, 124 and 132 formed therebetween. The use of planar surfaces may be advantageous, since it may enable control of the tilt of all of the elements in the lens system. The use of planar surfaces may also allow stacking of the elements and bonding directly to the planar surfaces, which may facilitate wafer level assembly. The planar surfaces may be left in the periphery around each element, or planar surfaces may be formed around the periphery of each lens element through deposition of suitable material.

Substrates in the optics stack 140 have optical elements thereon are transparent to wavelengths being imaged. Without additional structure, the edges of the substrates are exposed. Thus, as noted above, external stray light may enter through edges of these substrates, even with the opaque spacers, and may impinge of the active area. Additionally, light entering at high angles, i.e., outside the field of view of the camera, may be internally reflected at these edges and may impinge of the active area. However, by providing a light blocking material on the edges, the amount of stray light reaching the active area may be reduced.

In the first embodiment shown in FIG. 1, the light blocking material may be an encapsulant 192, which may be contained by a housing 190. Unlike housings used in designs not incorporating optics stacks, the housing 190 is very simple, and the optical elements are not secured directly thereto. The housing 190 may be opaque. The encapsulant 192 may be opaque, and may have a refractive index similar to that of the material of the substrates of the optics stack. For example, when the substrates are fused silica, having a refractive index of around 1.5, the encapsulant 192 may be a silicone gel sealant, e.g., HIPEC® R6102 SEMICONDUCTOR PROTECTIVE COATING from Dow Corning Corporation. Depending on a thickness of the encapsulant to be used, this known encapsulant may not be opaque enough. Therefore, material, e.g., carbon, may be added to this conventional encapsulant to make the conventional encapsulant more opaque. The encapsulant 192 may have a low modulus, i.e., may not induce much stress on the other elements, e.g., may avoid breaking of the wire bonds 176. While an opaque or absorptive material as the encapsulant 192 may reduce external light from entering the optics stack 140 other than at the entrance pupil, using a material that has a similar refractive index to that of the edges may reduce internal reflections within the optics stack 140.

After the pads 172 have been electrically connected to another substrate 180, e.g., a chip on board (COB), via wire bonds 176, an encapsulant 194 may be provided to protect the wire bonds 176. The substrate 180 may include features 182 thereon, e.g., a perimeter, to restrain the encapsulant 194. These features may be formed lithographically in or on the substrate, and may be at least 50 microns high. The encapsulant 194 may be the same as or different from the encapulant 192. The encapsulants 192, 194 may be provided simultaneously or sequentially.

Depending on the viscosity of an encapsulant material being used, the encapsulant material may be provided over an entire wafer of camera systems in manners similar to those used for bonding materials. For example, the encapsulant material may be provided sequentially, as set forth, for example, in U.S. Pat. No. 6,096,155, or simultaneously, as set forth, for example, in U.S. Patent 6,669,803, which are herein incorporated by reference. If the encapsulant material is provided simultaneously, some mask protecting an upper surface of the optics stack 140 may be employed. Other techniques, such as using a syringe or injection molding, may be used. Further, good coverage may require a multi-step process of applying the encapsulant, e.g., repeating appying and curing of the encapsulant.

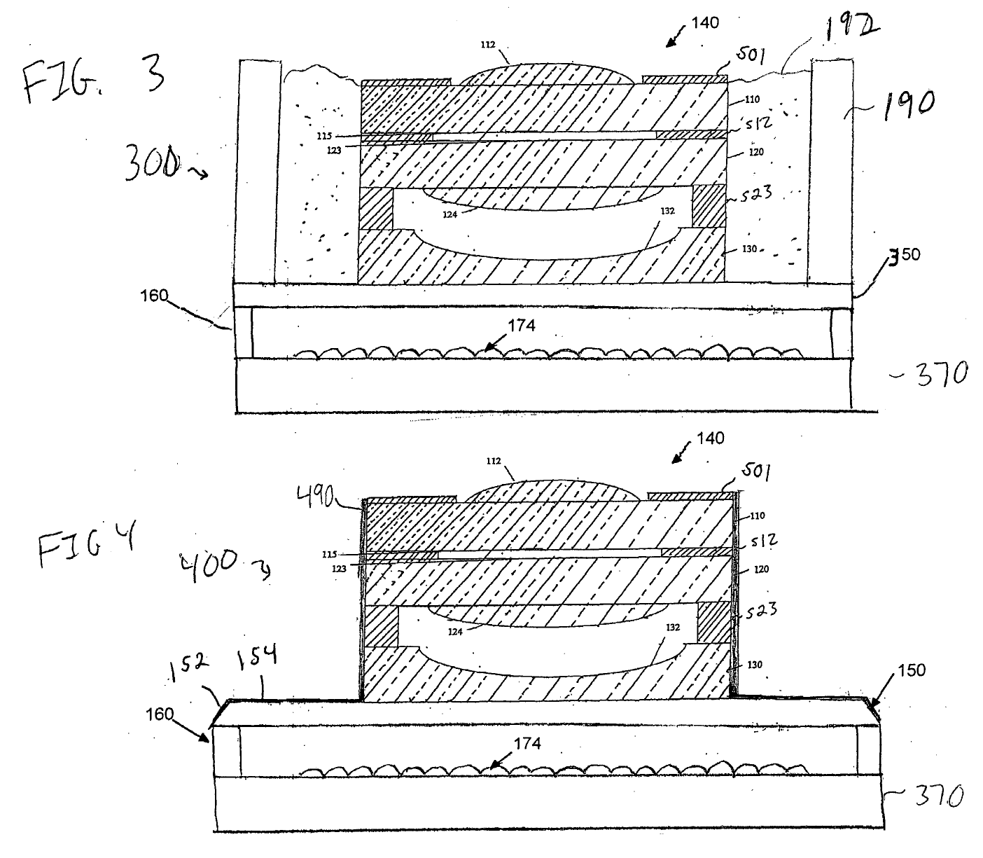

In a camera system 200 according to the second embodiment, as illustrated in FIG. 2, the housing 190 may be eliminated, and the same encapsulant 192 may be used to both reduce stray light in the optics stack 140 and protect wire bonds 176. Other elements of the second embodiment are the same as those in the first embodiment, and detailed description thereof is omitted.

In a camera system 300 according to the third embodiment, a detector substrate 370 may be configured to be surface mounted, e.g., using a ball grid array, to another substrate, thus eliminating wire bonds. However, the same housing 190 and encapsulant 192 illustrated in FIG. 1 may still be employed. Further, as shown in FIG. 3, edges of a cover plate 350 may be vertical. Also, as shown in FIG. 3, the housing 190, the cover plate 350 and the detector substrate 370 may be co-extensive. Other elements of the third embodiment are the same as those in the first embodiment, and detailed description thereof is omitted.

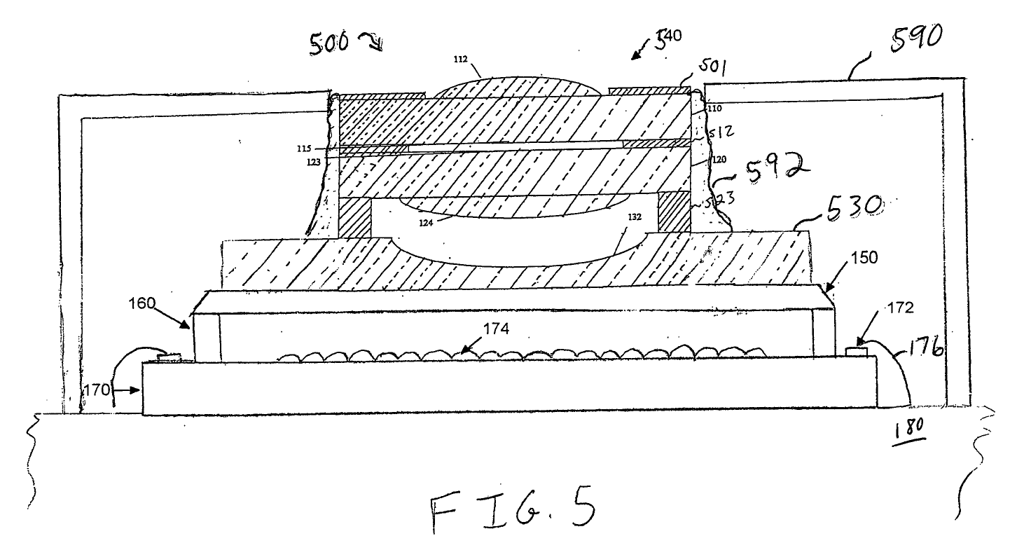

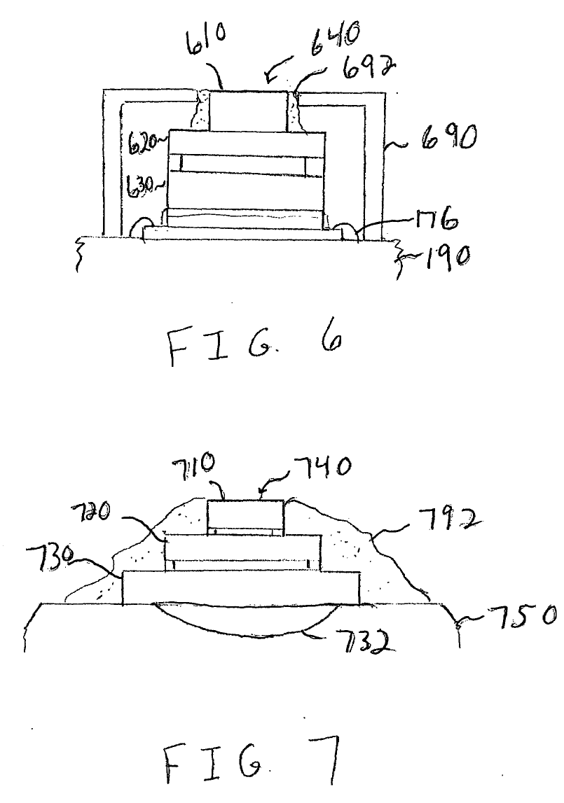

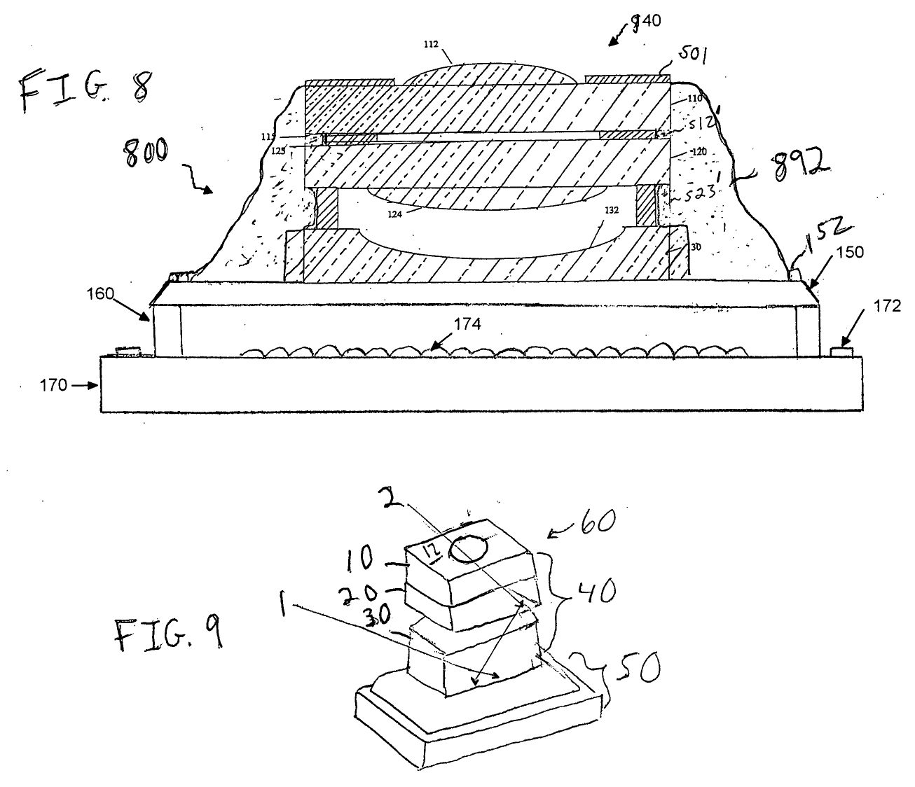

In a camera system 400 according to the fourth embodiment, as illustrated in FIG. 4, a coating 490 may replace the housing 190 and the encapsulant 192 of the third embodiment. The coating 490 may have similar properties as those of the encapsulant 192, i.e., be opaque and have a similar refractive index as the substrates, and may be the same material as the encapsulant 192.

As used herein, the term “coating” is to mean a material having substantially controlled thickness on a surface, and “encapsulant” is to mean a material that is conformally deposited. The coating 490 may be formed by evaporation, painting, immersion in, e.g., a liquid ink, etc. The coating 490 may be used even when the optics stack 140 is coextensive with the detector substrate 470.

When the coated optics stack 140, 490 is not coextensive with the detector substrate 470 or with the cover plate 150, as shown in FIG. 4, a light shielding element 154 may also be provided on the cover plate 150, e.g., the same material as used for the coating 490 or a different material, e.g., a metal. Further, a light shielding element 152 may be provided on the beveled edge, and may be the same as or different from the light shielding element 154.

Other elements of the fourth embodiment are the same as those in the third embodiment, and detailed description thereof is omitted.

In a camera system 500 according to the fifth embodiment, as illustrated in FIG. 5, a housing 590, e.g., an opaque housing, may protect the wire bonds 176 as well as contain an encapsulant material 592. A third substrate 530 of an optics stack 540 may extend beyond the first and second substrates 110, 120. The third substrate 530 may include features to further aid in restraining the encapsulant 592. The resultant stepped structure of optics stack 540 may be formed, for example, by securing the first and second substrates 110, 120 together on a wafer level, singulating the secured pairs, and securing the singulated pairs to the third substrate 530, or by securing all three substrates 110,120, 530, before singulation, and singulating by dicing, e.g., with different blade widths from different surfaces of the secured substrates. Here, the encapsulant 592 may also serve to protect elements of the camera system 500 from moisture and other environmental contaminants. Other elements of the fifth embodiment are the same as those in the first embodiment, and detailed description thereof is omitted.

In a camera system 600 according to the sixth embodiment, as illustrated in FIG. 6, a housing 690, e.g., an opaque housing, may protect the wire bonds 176 as well as contain an encapsulant material 692. A first substrate 610 of an optics stack 640 may have a smaller surface area than the second and third substrates 620, 630. The second substrate 620 may include features to further aid in restraining the encapsulant 692. The resultant stepped structure of optics stack 640 may be formed, for example, by securing a singulated first substrate to secured second and third substrates or by securing all three substrates before singulation, and singulating by dicing, e.g., with different blade widths from different surfaces of the secured substrates. Here, the encapsulant 692 may also serve to hermetically seal the camera system 600. The optics stack 640, as with any of the other embodiments, may be any suitable optics stack.

In a camera system 700 according to the seventh embodiment, as illustrated in FIG. 7, a stepped optics stack 740 may be used with just an encapsulant 792. This stepped optics stack 740 may help restrain the encapsulant 792 to insure good coverage thereof. In the particular optics stack-740 of the seventh embodiment, a first substrate 710 may be smaller than a second substrate 720, which, in turn, may be smaller than a third substrate 730.

A cover structure 750 may include a concave lens 732 therein. The cover structure 750 may include features to further aid in restraining the encapsulant 792. The resultant stepped structure of optics stack 740 may be formed, for example, by singulating each of the first through third substrates and then securing then together, singulated the secured pairs or by securing all three substrates before singulation, and singulating by dicing, e.g., with different blade widths from different surfaces of the secured substrates.

A camera system 800 according to the eighth embodiment, as illustrated in FIG. 8, may include an optics stack 840 including first through third substrates as in the first embodiment or as in the fifth embodiment. However, spacer S12′ between the first and second substrates and spacer S23′ between the second and third substrates may not extend to an edge of these substrates. This may be useful when the spacers S12′, S23′ are not made of materials that typically are subject to singulation, e.g., dicing. For example, when the spacers S12′, S23′ are SU8, these spacers S12′, S23′ may be provided such that they are out of the separation path of their respective substrates. An encapsulant 892 may then fill in these gaps between the spacers S12′, S23′ and an edge of the substrates to reduce stray light. The cover structure 150 may include features 158 to restrain the encapsulant 892.

Exemplary embodiments of the present invention have been disclosed herein, and although specific terms are employed, they are used and are to be interpreted in a generic and descriptive sense only and not for purpose of limitation. For example, while the substrates in the optics stack may all be the same material or may be different materials. When different substrate materials are employed, the refractive index of the light blocking material may be closest to that of a substrate most likely to internally reflect light or may be averaged across the substrates. Additionally, some or all of the optical elements in the optics stack may be replicated and be in plastic, rather than transferred to the substrate. Accordingly, it will be understood by those of ordinary skill in the art that various changes in form and details may be made without departing from the spirit and scope of the present invention as set forth in the following claims.

What is claimed is:

1. A camera system, comprising:
an optics stack including two substrates secured together in a vertical direction and an optical system on the two substrates, the two substrates having exposed sides;
a detector on a detector substrate; and
a stray light blocker directly on at least some sides of the optics stack.

2. The camera system as claimed in claim 1, wherein the at least some sides include sides on a substrate in the optics stack furthest away from the detector substrate.

3. The camera system as claimed in claim 1, wherein the stray light blocker is on all sides of the optics stack.

4. The camera system as claimed in claim 1, wherein the stray light blocker has an index of refraction that is approximately equal to that of a substrate having the at least some sides.

5. The camera system as claimed in claim 1, wherein one substrate in the optics stack has a smaller surface area than the detector substrate.

6. The camera system as claimed in claim 1, wherein the stray light blocker is an encapsulant.

7. The camera system as claimed in claim 1, wherein the stray light blocker is a coating.

8. The camera system as claimed in claim 1, wherein the stray light blocker is opaque to wavelengths the detector can detect.

9. The camera system as claimed in claim 1, wherein the substrates in the optics stack are coextensive.

10. The camera system as claimed in claim 1, wherein the detector substrate extends beyond the optics stack in at least one direction.

11. The camera system as claimed in claim 10, further comprising bonding pads on the detector substrate extending beyond the optics stack.

12. The camera system as claimed in claim 11, further comprising a substrate having elements to be electrically connected to the bonding pads.

13. The camera system as claimed in claim 12, wherein the stray light blocker includes an encapsulant extending from an upper surface of the optics stack to the detector substrate.

14. The camera system as claimed in claim 13, the encapsulant covers the bonding pads and electrical connectors between the bonding pads and the substrate.

15. The camera system as claimed in claim 13, further comprising features on the substrate restraining the encapsulant.

16. The camera system as claimed in claim 1, further comprising a housing surrounding the optics stack.

17. The camera system as claimed in claim 16, wherein the detector substrate extends beyond the optics stack in at least one direction.

18. The camera system as claimed in claim 17, further comprising bonding pads on the detector substrate extending beyond the optics stack.

19. The camera system as claimed in claim 18, further comprising a substrate having elements to be electrically connected to the bonding pads.

20. The camera system as claimed in claim 19, wherein the housing surrounding the optics stack extends down to the substrate.

21. The camera system as claimed in claim 20, wherein substrates in the optics stack are not coextensive.

22. The camera system as claimed in claim 21, wherein the housing extends to cover an upper portion of the optics stack extending beyond other substrates.

23. The camera system as claimed in claim 22, wherein the stray light blocker includes an encapsulant between an opening in an upper surface of the housing and the upper portion of the optics stack extending beyond other substrates.

24. The camera system as claimed in claim 16, wherein the stray light blocker includes an encapsulant between the housing and the optics stack.

25. The camera system as claimed in claim 16, wherein the housing extends to cover a cover plate on the detector substrate.

26. The camera system as claimed in claim 1, wherein substrates in the optics stack are not coextensive.

27. The camera system as claimed in claim 26, wherein the stray light blocker includes an encapsulant along the optics stack.

28. The camera system as claimed in claim 1, wherein a spacer separating the substrates in the optics stack includes a gap from the exposed sides.

29. The camera system as claimed in claim 28, wherein the stray light blocker includes an encapsulant along the optics stack, the encapsulant filling the gap.

30. The camera system as claimed in claim 1, further comprising electrical interconnections through the detector substrate.

31. The camera system as claimed in claim 1, wherein a cover plate on a detector substrate extends beyond the optics stack in at least one direction.

32. The camera system as claimed in claim 31, further comprising an opaque material on an exposed surface of the cover plate.

33. The camera system as claimed in claim 32, wherein the opaque material is the same as the stray light blocker.

34. The camera system as claimed in claim 31, wherein the cover plate has an angled edge and further comprising an opaque material covering the angled edge of the cover plate.

35. The camera system as claimed in claim 34, wherein the opaque material is the same as the stray light blocker.

36. A method of making a camera system, comprising:
securing an optics stack including two substrates secured together in a vertical direction and an optical system on the two substrates, the two substrates having exposed sides and a detector on a detector substrate; and
providing a stray light blocker directly on at least some sides of the optics stack.
